(19) United States
(12) Patent Application Publication
(10) Pub. No.: US 2006/0147351 A1
(43) Pub. Date: Jul. 6, 2006

(54) Diaphram metering chamber dispensing systems

(75) Inventors: Peter Falb, Hingham, MA (US); Charles W. Thaxter SR., Pepperell, MA (US); David Clare, Danvers, MA (US); Victor Sacco JR., Methuen, MA (US); Scott Leon, Fort Collins, CO (US); Shannon Lucia, Salisbury, MA (US); Eric R. Rioux, Quicey, MA (US)

Correspondence Address: SANTANGELO LAW OFFICES, P.C., 125 SOUTH HOWES, THIRD FLOOR, FORT COLLINS, CO, 80521, US

(73) Assignee: Dako Denmark A/S, (omitted)

(21) Appl. No.: 10/559,977

(22) PCT Filed: Jun. 9, 2004
(86) PCT No.: PCT/US04/18642

§ 371 Date: Dec. 9, 2005

(30) Foreign Application Priority Data
Jun. 9, 2003 (US) 60477382

(51) Int. Cl. B01L 3/00

(52) U.S. Cl. 422/100

(57) ABSTRACT

This invention describes a method and apparatus for a liquid dispensing cartridge pump suitable for dispensing reagent in an automatic system. In embodiments, the present invention may include a liquid metering chamber that accurately controls the amount of fluid dispensed. In other embodiments, the amount of fluid may be controlled by the action of a diaphragm, which may be assembled into a cavity of a dispenser housing creating a metering chamber. In another embodiment, the volume created by the metering chamber determines the volume of dispensed fluid. When the diaphragm is compressed from its free or extended state to its inverted state, it may substantially conform to the inner surface of the metering chamber. The fluid enters the metering chamber through an upper unidirectional valve and exits the dispenser housing through a lower unidirectional valve.

This is a PCT application claiming the benefit of U.S. of America Provisional Application No. 60/477,382, filed 09 Jun. 2003, hereby incorporated by reference.

### I. TECHNICAL FIELD

This invention relates to liquid dispensing systems and other devices which may be interchangeable and for dispensing small amounts of a liquid, such as a biological reagent, chemical reagent, or the like. The invention may include a liquid dispensing cartridge pump and methods for dispensing small amounts of liquids. It may also be applied specifically to automated systems for the pathology laboratory to perform special stains, immunohistochemical stains (IHC), or In Situ Hybridization (ISH).

### II. BACKGROUND OF THE INVENTION

It is understood that there are general methods for dispensing reagents in an automated system, including but not limited to, a repetitive non-disposable dispensing assembly design and a disposable dispensing assembly design. In one aspect, a repetitive non-disposable design may use pumps and tubing. One example may include an automated pipette. A pipetting device may draw fluid from a bottle and release the fluid onto the sample. This type of design may be cost effective since the reagents may be packaged in the same bottles and long-term material compatibility issues may be minimized. Among the disadvantages of non-disposable designs may be the continued maintenance to clean and flush tubing to prevent carryover and cross contamination. Further, a disadvantage may include exposure of reagents to air which can reduce their useful shelf-life.

A disposable design, generally, may be understood to include a syringe pump assembly. This design may also be known as a “piston plunger”. Some disadvantages of this design may be that a force required to depress a plunger can vary significantly and piston plunger dispensers can be susceptible to leakage due to tolerance and material compatibility issues. A plunger may employ an elastomeric seal, which may contact a syringe barrel, possibly providing a sliding or dynamic seal to retain fluid. From one perspective, this design may be applicable only for a limited number of reagents and chemicals that are compatible with the elastomeric seal, but it may not be adequately useful for a broad range of chemicals that may cause the seal to shrink or swell. However, tolerances required for proper operation of this kind of seal can be difficult to achieve in standard manufacturing processes and it is at this interface that material compatibility concerns may have adverse effects possibly leading to leakage if the elastomer shrinks or binding if the elastomer swells.

U.S. Pat. No. 4,844,868 to Rokugawa, U.S. Pat. No. 5,232,664 to Krawzak et al., and U.S. Pat No. 6,045,759 to Ford et al., appear to have somewhat attempted to modify a form of a syringe pump. Each of these devices can draw fluid into a syringe through a check valve and may be dispensed through a second check valve. From one perspective, each of the disadvantages noted above for syringe pumps apply here as they may relate to tolerance and material compatibility concerns. In addition, a design noted in U.S. Pat. No. 6,045,759 to Ford et al. appears to have the disadvantage that a vacuum created in the reagent reservoir should be released since a chamber may not be adequately collapsible. Some methods for vacuum release may be prone to blockage, tolerance issues, and may allow air to come in contact with the reagents. If air is in contact with a reagent, it may cause a decrease in the performance and stability of the reagent.

U.S. Pat. Nos. 5,645,114 and 5,316,452, both to Bogen et al. and U.S. Pat. Nos. 6,092,695 and 6,244,474 to Loeffler may include a liquid dispensing pump and a metering chamber attached to a liquid reservoir. While some systems may have a syringe pump design, other systems appear to have a compressible elastomeric metering chamber connected to a liquid reservoir and may include a flexible bag supported within a rigid housing. From one perspective these systems may have the following disadvantages: the materials utilized for flexible bags may not be adequately robust and can be susceptible to punctures, sealing failures, and material compatibility issues; the materials utilized for flexible bags can be susceptible to breakage due to the rigors of shipping; the compressible metering chamber, made of an elastomer, may have the disadvantages of permeability, dimensional inaccuracy, and failures related to material incompatibility, the capacity of the metering chamber can be much larger than the desired dispense volume; and the volume of the fluid dispensed may be determined by the dispensing mechanism on the automated system. Further, accuracy of the dispenser can be significantly impacted by the calibration of a dispensing mechanism on an automated system.

Previous devices do not adequately address issues related to reagent stability, material incompatibility, vacuum created when drawing fluid from a liquid reservoir, shipping robustness, and dispense accuracy, among others as addressed in the present invention.

### III. DISCLOSURE OF THE INVENTION

The present invention relates to a liquid dispensing system and other devices which allow for the dispensing of small amounts of liquids in an automated system. Systems may include a reservoir connected to a compressible metering chamber. A flexible diaphragm may compress or extend and uncompress or move to a free state while measuring and dispensing a precise amount of fluid.

It is an object of the present invention to provide a dispensing system that allows for vacuum build up while keeping an air-tight enclosed environment.

It is another object of the present invention to provide an accurate and repeatable dispensing system.

It is yet another object of the invention to provide a dispensing system that optimizes energy efficiency and utilizes less moving parts with a reduced amount of friction.

It is an object of the invention to provide an interchangeable liquid dispensing cartridge pump.

It is yet another object of the invention to provide an automated dispensing system.

Naturally, further goals and objects of the invention are disclosed throughout other areas of the specification and claims.

### IV. BRIEF DESCRIPTION OF THE DRAWINGS

The foregoing and other objects, features and advantages of the invention will be apparent from the following more particular description of the invention, as illustrated in the accompanying drawings.

FIG. 1 shows a sectional view of an embodiment of the invention of a reservoir and dispenser assembly.

FIG. 2 shows a side view of an embodiment of the invention of a reservoir without housing and a dispenser assembly.

FIG. 3 shows an embodiment of the invention of a reservoir and housing assembly.

FIG. 4 shows a partial view of an embodiment of the invention of a dispenser assembly.

FIG. 5 shows a sectional, partial view of an embodiment of a dispenser assembly without a reservoir and outlet unidirectional valve.

FIG. 6 shows a sectional view of an embodiment of an outlet unidirectional valve assembly.

FIG. 7 shows a sectional view of an embodiment of a diaphragm in a free state or uncompressed state.

FIG. 8 shows a sectional view of an embodiment of a diaphragm in a compressed state.

FIG. 9 shows a sectional view of an embodiment of a metering chamber having an open inlet unidirectional valve and a closed outlet unidirectional valve.

FIG. 10 shows a sectional view of an embodiment of a metering chamber having a closed inlet unidirectional valve and an open outlet unidirectional valve.

FIG. 11 shows a perspective view of an embodiment of a reservoir housing connected to a dispenser assembly and an unassembled dual clamp element.

FIG. 12 shows a perspective view of an embodiment of an assembled reservoir housing.

FIG. 13 is side view of a collapsible molded reservoir in an expanded state.

FIG. 14 is a side view of a collapsible molded reservoir in a partially collapsed state.

### V. MODE(S) FOR CARRYING OUT THE INVENTION

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should further be understood to support and encompass descriptions and claims of all the various embodiments, systems, techniques, methods, devices, and applications with any number of the disclosed elements, with each element alone, and also with any and all various permutations and combinations of all elements in this or any subsequent application.

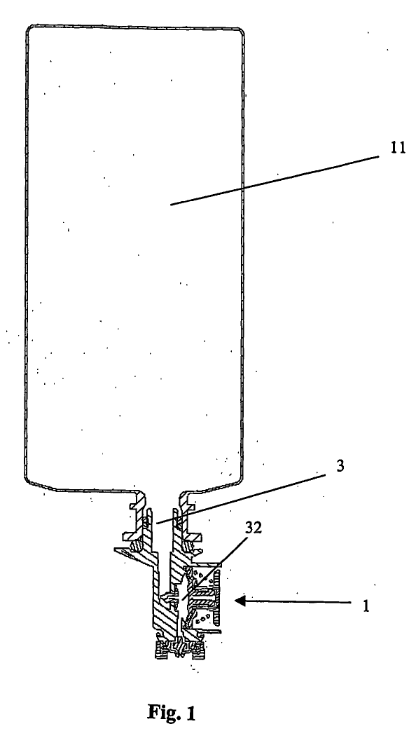

In embodiments, a liquid dispenser apparatus and methods of dispensing liquids may include a liquid reservoir (11) and may even provide for establishing liquid in a reservoir. A reservoir may be a receptacle, chamber or the like containers for holding a liquid or fluid. A reservoir may be located near a dispenser assembly (1) or may even be remote and may be fluidly connected to a compressible metering chamber (32). A compressible metering chamber may move from between a compressed and uncompressed position and may even include a compressible diaphragm. In other embodiments, a reservoir may be located above a metering chamber. A metering chamber may be a compartment, cavity or closed space that may be used for measuring an amount of liquid or fluid. In embodiments, a metering chamber (32) may be connected to a reservoir with a liquid introduction element (3) such as seen in FIG. 1. A liquid introduction element may include tubing, a channel (6) or the like fluid flowing element. Fluid may enter a metering chamber through an upper or inlet unidirectional valve (34) or similar type element and may exit a metering chamber through a lower or outlet unidirectional valve (25) or similar type element.

It may be desirable to provide a sealed system from a reservoir to an outlet unidirectional valve. Outside air may cause chemical degradation and may damage or impair tests or samples that may be used in conjunction with a dispenser system. As such, the present invention, in embodiments, may provide for sealingly attaching a metering chamber to a reservoir and may provide a seal (5) located between a reservoir and a liquid introduction element (3). A connection or connections between a reservoir and a metering chamber (32) may be sealed by either or both radial and flange seals or the like. In another embodiment, the present invention a seal may include a radial o-ring seal (21), a flange o-ring (22) and the like seals to create a seal between the reservoir and a metering chamber (32).

A reservoir may be interchangeable and disposable, in embodiments, or may even be refillable and re-useable, in other embodiments. Accordingly, a reservoir may include an interchangeable reservoir or may even include a refillable reservoir. In method systems, the present invention may include interchanging a reservoir and may even include refilling a reservoir. An opening, such as a screw cap, snap or the like may be added to a reservoir in which liquid may be poured into the reservoir. In contrast, a reservoir may be pre-filled with liquid and when empty, a reservoir may be replaced with a new pre-filled reservoir.

In embodiments, the present invention may include a liquid metering chamber that may accurately control an amount of fluid dispensed. An amount of fluid may be controlled by action of a diaphragm or other flexible element, which may be assembled into a cavity of a dispenser housing (24). This may cause volumetric changes and may even create a metering chamber. A static seal may prevent leakage of fluids within a metering chamber and throughout a dispensing system. Action of a diaphragm may not be collinear or axially related to a liquid flow or reagent stream. A diaphragm action may be non-linear to a reagent stream. In other embodiments, a volume created by the metering chamber may determine a volume of dispensed fluid.

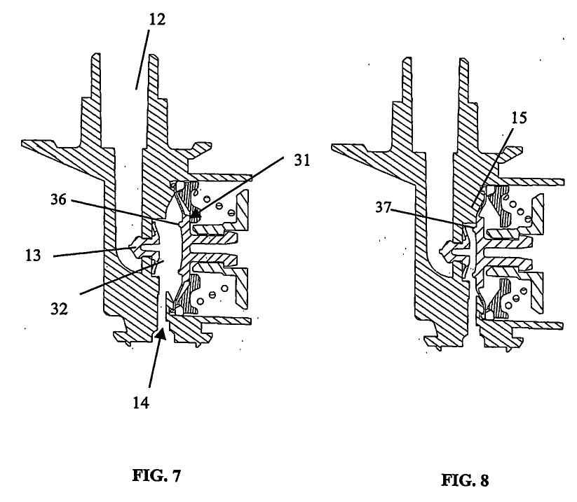

In embodiments, a metering chamber may include an enclosed chamber or cavity that may have a flexible diaphragm (33). A flexible diaphragm may be displaced between compressed (37) and uncompressed positions (36), as seen in FIGS. 7 and 8. By compressed and uncompressed, it can be understood that a diaphragm may be a flexible membrane that can be displaced, bent, translated, conformed and the like. For example, a diaphragm may be placed in a compressed position (37) as seen in FIG. 8 or a diaphragm may be placed in an uncompressed position (36) as seen in FIG. 7. When a diaphragm is displaced from a free, extended or uncompressed position (36) to an inverted or compressed position, it may substantially conform to an inner surface of a metering chamber. In a compressed position (37), a diaphragm may be capable of substantial conformation to at least part of a metering chamber. Specifically, in embodiments, a diaphragm may be capable of substantially conforming to a wall (15) of metering chamber. By conformation and conforming, it is to be understood that at least part of a diaphragm may become similar in form to an internal wall (15) of a metering chamber, such as seen in FIG. 8. In embodiments, a flexible diaphragm may be concave in its relaxed or uncompressed state and may be partially convex in its compressed state.

Opposite a metering chamber and attached to the dispenser housing (24) may be a unidirectional valve or the like element. At the bottom of the dispenser housing, a second unidirectional valve assembly, or the like element, may be attached. The assembly may utilize a disk that may even serve the dual purpose of a sealing surface and a flow director (19).

An inlet unidirectional valve (34) may connect a liquid introduction element (3) to a metering chamber and may provide an entrance for liquid into a metering chamber. An inlet unidirectional valve may open and close. When an inlet unidirectional valve is open, it may allow fluid to flow from a reservoir through a liquid introduction element and into a metering chamber. Contrarily, an inlet unidirectional valve may also prevent liquid from flowing into a metering chamber when it is closed. Liquid from a reservoir may flow through at least one liquid flow opening (7) and a membrane (8) of an inlet unidirectional valve (34). Of course, there may be other embodiments in which more than one liquid flow opening may be utilized, such as four or more liquid flow openings, and all are intended to be included in this disclosure. In an open position (9), an inlet unidirectional valve may have a membrane (8) positioned away from said liquid flow opening (7) so as to allow liquid to flow into a metering chamber. In a closed position (10), a membrane may close a liquid flow opening and even create a seal. In other embodiments, a positive seal may be formed in an inlet unidirectional valve.

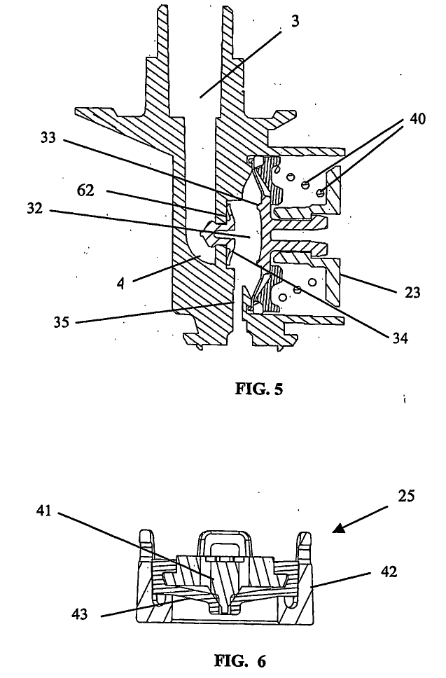

In yet other, embodiments, the present invention may provide a liquid flow deflection element (4) and may even provide deflectingly flowing an amount of liquid from a reservoir to a metering chamber through an inlet unidirectional valve. A liquid flow deflection element (4) may include a vertical flow element (12) below a reservoir and a horizontal flow element (13) next to a metering chamber. The present invention may include vertically flowing liquid out of a reservoir and horizontally flowing liquid into a metering chamber. To provide this, the present invention may include locating a reservoir somewhat above a metering chamber and locating an inlet unidirectional valve on a side (62) of a metering chamber as shown in FIG. 5. A vertical flow element (14) may be located below a metering chamber providing a vertically flowing liquid out of a metering chamber.

A diaphragm may be compressed and uncompressed with a plunger (23). A plunger (23) may be any structure and even a circular structure that may move a diaphragm. An actuator (16) may apply force to a plunger to move or even displace a diaphragm from one position to another. In embodiments, the present invention may provide horizontal displacement of a flexible diaphragm between compressed and uncompressed positions. This may include a substantially vertical diaphragm capable of moving in a horizontal direction. As such, in embodiments, a plunger may be configured to horizontally displace at least part of a metering chamber such as, a flexible diaphragm. In embodiments, the present invention may include a compression element and an uncompression element. A compression element may include a manual compression element or may even include an automatic compression element. Manual compression may include compression done or operated by a hand or hands rather than by an electrical or electronic device. Automatic compression may include compression that can be independently operated by an electronic device, such as but not limited to a stepper/servo control, a motor, an air cylinder or the like.

An uncompression element may include a force that can uncompress or displace a diaphragm to an uncompressed state. For example, an uncompression element may include a spring (40) which may be connected to a plunger (23). For clarity, a spring is not fully shown in the figures. The spring (40) apertures are meant to be representative of where a spring may be located. A force may be applied to a plunger which may compress a spring and displace a diaphragm. When this force is removed, a spring may uncompress and move a plunger along with a diaphragm in the opposite direction. In embodiments, a flexible diaphragm (33) may be displaced from a compressed position to an uncompressed position with a spring.

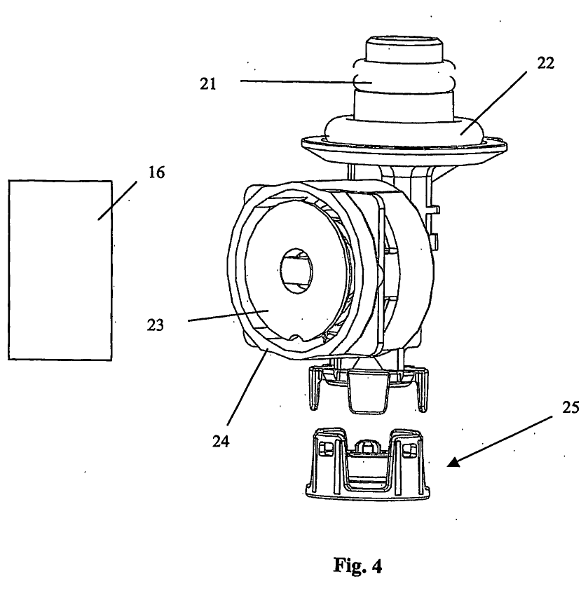

A liquid exit element (17) may be connected to a metering chamber and may even have an outlet unidirectional valve (25). In embodiments, the present invention may include distributing an amount of liquid from a metering chamber through an outlet unidirectional valve. A liquid exit element (17) may include a narrow channel (35) between a metering chamber and an outlet unidirectional valve (25). A lower or outlet unidirectional check valve assembly, as seen in FIGS. 4 and 6, may attach to a dispenser housing (24). An outlet unidirectional valve (25) may only allow liquid to flow in one direction and may include an open position (46) and a closed position (45). An outlet unidirectional valve may include at least one liquid flow opening and a membrane. In an open position (46), an outlet unidirectional valve may have a membrane positioned away from a liquid flow opening (20) so as to allow liquid to flow out of a metering chamber. In a closed position (45), a membrane may close a liquid flow opening and even create a seal.

In some embodiments, an outlet unidirectional valve may include, but is not limited to, a valve disk (41), a valve retainer (42), and a valve membrane (43). A valve retainer may form a seal between a valve membrane and a metering chamber. A valve disk may have a conical protrusion, a conical disk or other shape that may form a seal with a valve membrane. A valve membrane may be a flexible membrane. Of course, other shapes of disks are certainly possible. A valve disk may provide a seal surface and may even provide a flow director (19) which may direct a liquid flow through an outlet unidirectional valve. A seal may be formed between a protrusion on a valve disk and an orifice on a valve membrane because the protrusion on a valve disk may deform a flexible valve membrane and may keep it under tension. In embodiments, an outlet unidirectional valve may be sealingly attached to a metering chamber and may even provide for positively sealingly attaching an outlet unidirectional valve to a metering chamber. An elastic force of a valve membrane may provide a positive fluid seal for the dispenser assembly. Fluid pressure may separate a valve membrane from a valve disk during a dispense cycle and fluid may be expelled through an orifice in a valve membrane. A valve retainer may allow the attachment of a unidirectional valve assembly to a dispenser housing (24). Further, a seal may be located between the lower valve retainer (42) and the dispenser housing (24). In an embodiment, a lower valve membrane (43) may be located near the lower valve disk (41).

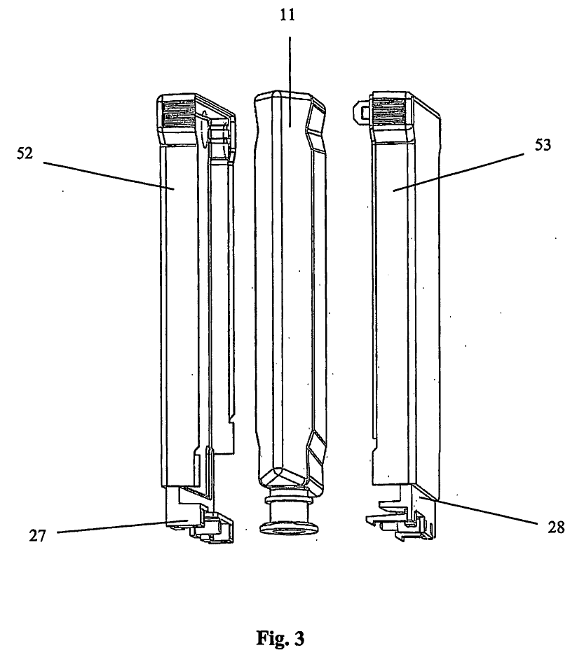

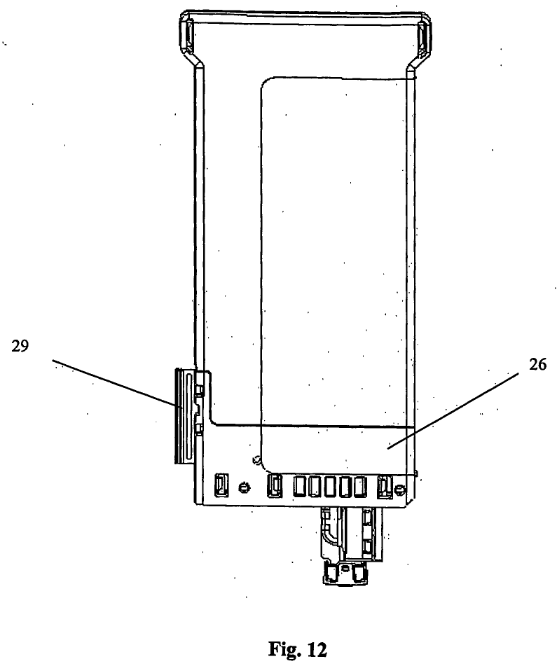

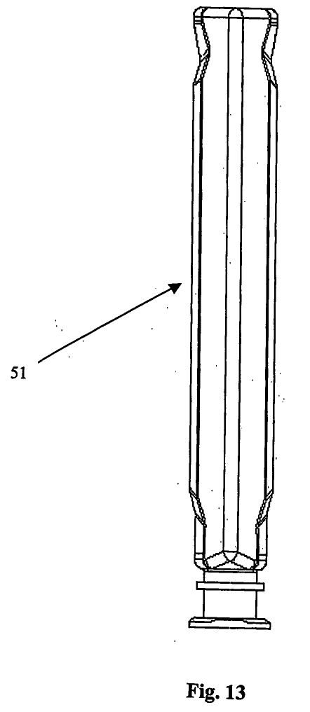

The present invention may include a dual clamp element (26) as can be understood in FIGS. 3, 11 and 12. The present invention may include clamping a reservoir to a metering chamber and may even include attaching a reservoir and a metering chamber to an automated system. This may be provided with a dual clamp element (26) which may connect a liquid reservoir (11) to a metering chamber and may even connect or register a reservoir and metering chamber to an automated system. A clamp may include, but is not limited to, a left clamp (27) and a right clamp (28) and may even include an automated system attachment (29), as seen in FIGS. 3 and 12. The mechanism of attachment for the dispenser assembly and fluid reservoir may serve at least two purposes. It can clamp the liquid reservoir to the dispenser housing and may even provide a mounting feature for location on an automated system. Elastomeric o-rings or the like element may be used in either or both a radial and flange configuration at an interface between a liquid reservoir and a dispenser housing to prevent fluid leakage.

The present invention may include, in embodiments, creating a vacuum in a metering chamber. A vacuum may be an enclosed space from which matter, such as air, has been at least partially removed so that the matter or gas remaining in the space exerts less pressure than the atmosphere. When a metering chamber moves between compressed and uncompressed positions, a vacuum may be created as liquid is dispensed. A vacuum created by the compression and release of a diaphragm may draw fluid from a reservoir into a metering chamber through an inlet unidirectional check valve. A precise volume of fluid may be drawn from a reservoir and dispensed from a metering chamber through an outlet unidirectional valve during a dispense cycle.

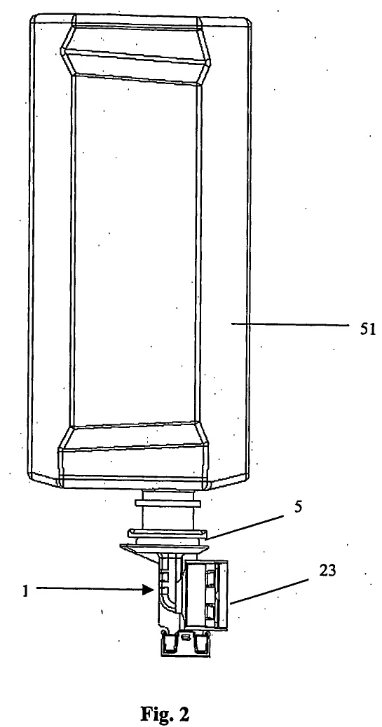

In embodiments, a liquid reservoir may include a collapsible molded reservoir (51) and even a collapsible plastic molded bottle, as shown in FIG. 2. A collapsible molded reservoir may include a single piece collapsible molded reservoir or a one piece structure. The material properties of a bottle may be highly compatible with most chemical and biological reagents. A collapsible molded reservoir may include a chemically compatible material such as but not limited to polyolefin, inert materials, elastic materials and the like. A vacuum that may be built up inside a reservoir from the dispensing of fluid may not need to be released due to the fact that a reservoir may include a collapsible bottle. A vacuum may at least partially collapse a molded reservoir. The material and thickness of a bottle may be such that evaporation and permeability are minimized while at the same time may even allow for a bottle to collapse due to the vacuum created from the withdrawal of fluid. It may be desirable, in embodiments, to provide balancing of a collapsibility of a collapsible molded reservoir with a durability of a collapsible molded reservoir.

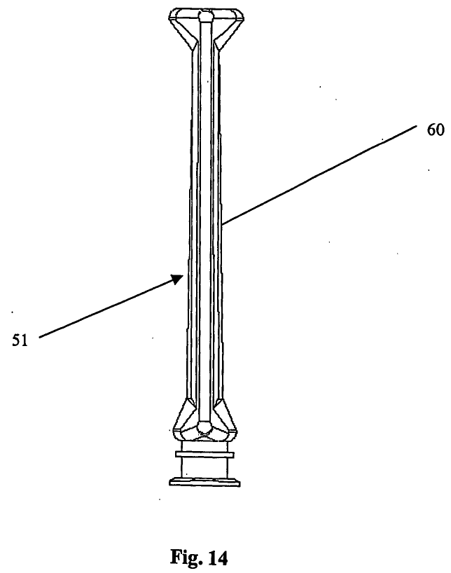

In other embodiments, the present invention may include a collapsible molded reservoir (51) that may be a structured bottle which can yield to vacuum forces and yet substantially maintain its shape even when it is partially or fully collapsed. This may provide a reservoir or bottle that does not puncture and leak fluids. In embodiments, a molded reservoir may be made of a material that allows it to substantially maintain its structure. In embodiments, a reservoir may begin to collapse due to a vacuum in a metering chamber, and a reservoir may maintain or at least in part maintain its original shape or structure except for partial or even full indentation of the walls (60) of the reservoir, as may be shown in FIGS. 13 and 14.

The forces required to collapse a bottle may be less and may even be significantly less than the forces required to displace a diaphragm. In embodiments, the present invention may include a reservoir collapse force less than a force required to uncompress a metering chamber and may even provide at least partially collapsing a collapsible molded reservoir with a force less than a force required to uncompress a metering chamber. A diaphragm can return to its uncompressed or free state with the assistance of an uncompression element, such as a spring or the like element.

In some embodiments, a diaphragm assembly may consist of at least a plastic molded diaphragm, a compression spring and a dispense plunger. A dispense plunger may be snapped onto a molded diaphragm. A material for a molded diaphragm may have similar properties as that described herein for a liquid reservoir. A diaphragm may be placed in a cavity in a dispenser housing forming a metering chamber. A diaphragm may form a static seal against a dispenser housing when a retainer, or the like element, and an elastomeric o-ring, or the like element, may be snapped into position against the outside of the diaphragm. Further, in embodiments, fluid may be moved through the metering chamber without any sliding parts. The fluid may simply be dispensed with non-sliding parts or may even be dispensed with reduced friction. Sliding parts may create friction, as it may be understood to occur in the syringe pump design. The disadvantages of syringe pump designs, such as the elastomer to chemical reagent incompatibility and elastomeric seal to syringe barrel tolerance concerns, may be eliminated since a fluid seal may be static in embodiments. Accordingly, the present invention may include, in embodiments, a reduced friction dispenser and may even provide minimal sliding parts. The present invention reduces the amount of friction created and allows for conservation of energy.

To prime a metering chamber, a dispenser assembly may be compressed and released. Compression of a plunger may be accomplished by either manual method or automation methods. A user of the reagent cartridge could depress a plunger with a finger or thumb to prime the system initially. An automated system, as previously discussed, could use a number of devices to compress a plunger such as, but not limited to a stepper/servo motor, an air cylinder, or the like element. In embodiments, a dispenser assembly may be primed or used by compressing a plunger and releasing a plunger. This may be accomplished by manual operation or even by automated operation.

The present invention may include, in embodiments, tip-down priming a metering chamber with a tip-down priming element. Past attempts may have required a tip to be facing up so that air bubbles that may be trapped are released at the top. Air bubbles may be then evacuated by drawing them out with a syringe or other means. The use of an additional syringe may be both complicated and costly. Tip up priming may be inherently unsafe and can even require additional precautions to prevent harmful contact with the chemical being primed. The present invention may provide little or negligible amounts of air that can be trapped in a system. In embodiments, the shape of the diaphragm may match or even closely match the contour of the inner surface of the dispenser housing when the diaphragm is compressed using the method described above. This design may force any trapped air through a narrow channel, which may be formed in the dispenser housing, and out of the lower unidirectional valve. A narrow channel may minimize a dead volume of reagent chemistry. Dead volume may be the volume that is not directly contained in the metering chamber and may not be expelled during the priming and/or normal dispense operation. A narrow channel may minimize the amounts of reagent or liquid not directly contained in the metering channel.

In an embodiment, a vacuum created inside the metering chamber, when a diaphragm is returned to its free state or uncompressed position, may open up an upper unidirectional valve. Fluid from a liquid reservoir (11) may flow into the metering chamber. A dispenser assembly (1) may be self-priming because there may be little dead-volume in the metering chamber and the shape of the cavity in the dispenser housing may closely match the shape of the diaphragm in the extended state. Accordingly, the present invention may include, in embodiments, self priming a metering chamber and may even include a self priming element. A self priming element may include a flexible diaphragm and a metering chamber.

For each dispense cycle, an equal volume of fluid may be drawn from the reservoir and dispensed from the dispenser housing through the lower unidirectional check valve. A dispense cycle may be defined as one series of displacing a diaphragm to an extended state or compressed position and displacing a diaphragm in its free state or uncompressed position. A compression spring may overcome a vacuum formed inside the liquid reservoir to return the diaphragm to its free state or uncompressed position (36), as shown in FIG. 7. The accuracy and consistency of a dispensed fluid may be tightly controlled due to the fact that a metering chamber volume can remain the same. A spring can return a diaphragm to an internal mechanical stop (31) in its free state or uncompressed state and the compressed state of the diaphragm may be controlled by the inner surface of the dispenser housing. Accurate and repeatable dispense volume can be critical for an automated system. The requirements and justification for an automatic system may be consistency across a multitude of tests and operations. The present invention may be less susceptible to variations and tolerances than other presently available dispensing apparatus utilizing the disposable dispensing assembly design approach.

In yet other embodiments, the present invention may provide for staining a biological sample with a distributed amount of liquid from a metering chamber. In order to achieve this, the present invention may provide a biological sample located directly below a liquid exit element. A biological sample may include tissues, cells, other elements that may pertain to living organisms, or the like samples which may be desirable to process in a staining method. For example, but not limited to, staining methods and biological stains may include immunohistochemical stains, in Situ Hybridization, special stains or the like stains. In other embodiments, the present invention may include an automated system for automated biological staining and may even use an automated system attachment as previously described.

The present invention may extend the usable shelf life of the chemistry stored in a liquid reservoir due to the fact that air may not be introduced into the system during the dispensing process and may even be a non-air exposing system. Other dispensing systems may require the release of vacuum, which is created as the fluid is evacuated from the reservoir. Further, other designs may utilize a valve or vented cap. A collapsible bottle design in embodiments of the present invention may not require air introduction. In other embodiments, the present invention may provide limited light exposure. Some chemicals may be sensitive to light and may degrade with exposure to light. This may be accomplished by a reservoir housing which may keep light out of a reservoir and may even be accomplished by providing a non-light permeable structure for a metering chamber and the like.

In embodiments, the flexible liquid reservoir may be molded from a polyolefin material, or the like materials. Past attempts have utilized flexible liquid reservoirs made from a film material, which may then be manufactured into a bag. Bags may be manufactured using unreliable sealing methods to form a container. A seal formed during the heat and compression manufacturing method can be susceptible to voids, holes, and non-uniformity. From one perspective, molding a flexible reservoir may be cost effective, reliable, and provide a uniform seal. Polyolefin material may be inert to most chemicals due to its homogeneity nature and material properties of polyolefin may also provide a a modulus of elasticity that may minimize the forces required to collapse a reservoir.

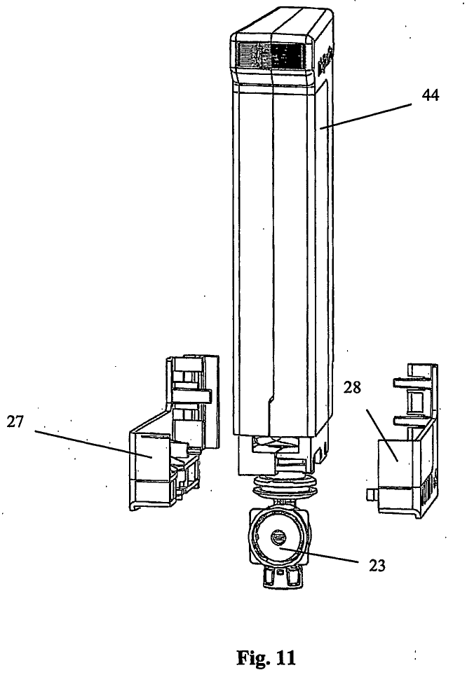

In other embodiments and as shown in FIG. 11, a reservoir housing (44) may be used to contain a reservoir and may even be attached around a reservoir. Reservoir housing (44) may include, but is not limited to, a left housing element (52) and a right housing element (53), as shown in FIG. 3. Of course, a housing may be any number of pieces. A reservoir housing may provide a surface for identification by either an automated instrument or a user. It may also provide protection and support for a reservoir. In an embodiment, the present invention may include a reservoir assembly in which the reagent may be contained.

In an embodiment, the end of travel for the diaphragm, which may be part of the metering chamber, may be controlled by a hard stop. This feature can eliminate the need for calibration of this assembly. Other designs may require the travel of the actuation device, for example, stepper/servo motors, air cylinders, and the like, to be calibrated to account for mechanical tolerances, which may be introduced as part of the assembly process. With this invention, a dispensed volume can remain consistent from position to position within an automated instrument or between multiple instruments. Dispense volume repeatability can be critical for consistent sample processing on the automated system.

In embodiments, the design of the metering chamber may allow for the use of a shipping lock. This feature may hold the diaphragm in a compressed position. A feature or element on the diaphragm may be positioned to contact the upper unidirectional valve and may prevent the flow of a liquid, such as a reagent, into the metering chamber. This unique and novel feature may serve two purposes. It may increase the shelf life of the product and it may prevent fluid from dripping during shipping. In embodiments, the present invention may include locking a metering chamber with a shipping lock to prevent liquid from flowing out of a reservoir. A shipping lock may hold a diaphragm in a compressed position to prevent liquid flow from a reservoir and a liquid introduction element from entering a metering chamber. A compressed position may further hold a inlet unidirectional valve in a closed position.

A flexible diaphragm (33) may be a single piece flexible diaphragm or even a one piece structure. In embodiments, a diaphragm may be plastic molded and may even be a flexible membrane. It may be desirable to provide a diaphragm that is made out of a chemically resistant material, such as a polyolefin material. A flexible diaphragm utilized in an embodiment of the present invention may be unique in that it may provide a flexible membrane that is chemically resistant and may also contain features to allow it to connect to the dispense plunger. Past attempts for flexible chemically resistant diaphragms may have been made from a sheet of plastic and may not adequately have mounting features or may be made out of a plastic and rubber composite that may contain either an inserted plastic or metal feature to connect to the dispense mechanism. Again, as mentioned earlier, in embodiments of the present invention, polyolefin material may be used and may be inert to most chemicals due to its homogeneity nature. The material properties of the polyolefin material used for the manufacture of the diaphragm may also provide a modulus of elasticity that minimizes the forces required to compress it.

The present invention may include internally compressing a diaphragm with an internal diaphragm compressor. This may include compressing a diaphragm internally within a metering chamber structure wherein a plunger and diaphragm may be located within a structure, such as a metering chamber.

The present invention may include repeatably measuring an amount of liquid in a metering chamber. A metering chamber may include a repeatable liquid measurement element, which may provide measuring amounts of liquid accurately with each compression of a metering chamber. For example, a metering chamber may have a liquid measurement amount of about 250 microliters (μl) which may be distributed from a metering chamber with each dispense stroke. A reagent pack or reservoir may be filled to about 120 milliliters (ml) for a total of one hundred, four stroke tests or a total of four hundred total dispenses. In embodiments, 20 milliliters (ml) may be used for priming. As but one additional example, a reservoir may include about 4 ml of fluid and a dispense amount may include about 500 micro liters. Of course, other dispense amounts and reservoir amounts are certainly possible and all are meant to be included in this disclosure.

A volume of the dispensed amount may be defined by an inside cavity of a dispense chamber or metering chamber formed on one side by a diaphragm and on another side by a dispenser housing or a wall of a metering chamber. Each dispense stroke may be accurate for any type of liquid which may be dispensed. Of course, in embodiments, a dispenser assembly may not adequately dispense viscous liquids. A full stroke may dispense the entire liquid content inside a dispense chamber or metering chamber. To accurately measure each amount of liquid, the present invention may include stopping a diaphragm in a metering chamber at an internal mechanical stop (31). An internal mechanical stop may stop displacement of a metering chamber or even a diaphragm at a uncompressed position.

Generally, a dispensing system may operate by displacing a diaphragm from a compressed position to an uncompressed position. A vacuum may be created which allows liquid to pass from a reservoir into a liquid introduction element and flow into a metering chamber through an open inlet unidirectional valve. An inlet unidirectional valve will open while an outlet unidirectional valve can close. When a metering chamber may be full, a diaphragm may begin to move from an uncompressed position to a compressed position. An inlet unidirectional valve may close and an outlet unidirectional valve may open allowing the measured liquid to flow out of a metering chamber through an exit element.

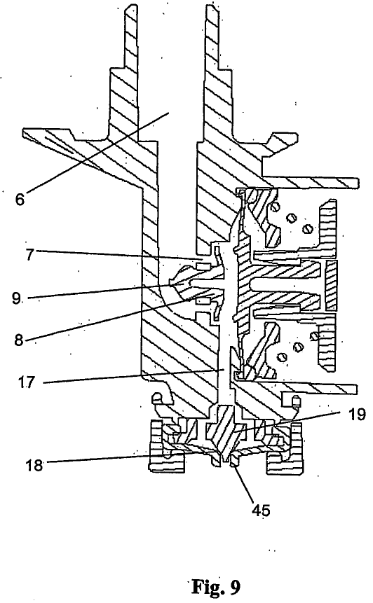

In FIG. 9, an embodiment of a dispenser system is shown when a plunger and diaphragm may be moving from a compressed state to a free or uncompressed state by action of an internal spring. In this diagram, an outlet unidirectional valve may be closed and an inlet unidirectional valve may be open. This may allow fluid to enter a metering chamber from a collapsible fluid reservoir. In this situation, vacuum builds which may close an outlet unidirectional valve immediately and may open an inlet unidirectional valve or umbrella valve once the “cracking pressure” has been reached.

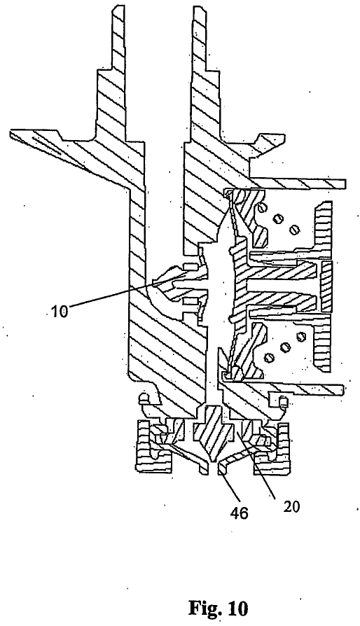

FIG. 10 shows an embodiment of a dispenser system when a plunger and diaphragm may be moving from a free or uncompressed position to a compressed position as it is being actuated by a staining instrument. In this figure, an inlet unidirectional valve or even an umbrella may be closed and an output unidirectional valve may be open. This may allow fluid to exit a metering chamber and dispense onto test samples. In this situation, pressure may build inside a metering chamber. A pressure may immediately close an inlet unidirectional valve and can open an outlet unidirectional valve once a “cracking pressure” or an opening pressure of an outlet unidirectional valve has been reached.

As can be easily understood from the foregoing, the basic concepts of the present invention may be embodied in a variety of ways. It involves both dispensing techniques as well as devices to accomplish the appropriate dispenser. In this application, the dispensing techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims which will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “dispenser” should be understood to encompass disclosure of the act of “dispensing”—whether explicitly discussed or not—and, conversely, were there effectively disclosure of the act of “dispensing”, such a disclosure should be understood to encompass disclosure of a “dispensing” and even a “means for dispensing”. Such changes and alternative terms are to be understood to be explicitly included in the description.

U.S. Patent Documents

| DOCUMENT | | | | SUB | FILING |
|---|---|---|---|---|---|
| NO. | DATE | NAME | CLASS | CLASS | DATE |
| 4,844,868 | 7/4/1989 | Rokugawa | 422 | 64 | 6/11/1986 |
| 5,232,664 | 8/3/1993 | Krawzak | 422 | 64 | 9/18/1991 |
| | | et al. | | | |
| 5,316,452 | 5/31/1994 | Bogen | 417 | 412 | 5/11/1992 |
| | | et al. | | | |
| 5,634,391 | 6/3/1997 | Eady | 92 | 97 | 7/09/1996 |
| 5,645,114 | 7/8/1997 | Bogen | 141 | 145 | 5/31/1994 |
| | | et al. | | | |
| 5,947,167 | 9/7/1999 | Bogen | 141 | 1 | 7/02/1997 |
| | | et al. | | | |
| 6,045,759 | 4/4/2000 | Ford | 422 | 103 | 12/19/1997 |
| | | et al. | | | |
| 6,092,695 | 7/25/2000 | Loeffler | 222 | 207 | 2/10/1998 |
| 6,183,693 | 2/6/2001 | Bogen | 422 | 64 | 02/27/1998 |
| | | et al. | | | |
| 6,180,061 | 1/30/2001 | Bogen | 422 | 64 | 12/04/1998 |
| | | et al. | | | |
| 6,244,474 | 6/12/2001 | Loeffler | 222 | 207 | 7/6/2000 |

All patents, publications, or other references mentioned in this application for patent or listed in the above listing are hereby incorporated by reference. The priority case, U.S. of America Provisional Application No. 60/477,382, filed 09 Jun. 2003, is hereby incorporated by reference including any figures or attachments. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed herein or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the dispenser devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC § 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A liquid dispenser apparatus comprising:
a collapsible molded reservoir;
a compressible metering chamber fluidly connected to said collapsible molded reservoir with a liquid introduction element;
a liquid flow deflection element;
an inlet unidirectional valve which connects said liquid introduction element to a metering chamber;
a flexible diaphragm capable of substantial conformation to at least part of said metering chamber;
a plunger configured to horizontally displace said flexible diaphragm; and
a liquid exit element connected to said metering chamber having an outlet unidirectional valve.

2-6. (canceled)

7. A liquid dispenser apparatus comprising:
a liquid reservoir;
a metering chamber fluidly connected to said liquid reservoir with a liquid introduction element;
an inlet unidirectional valve which connects said liquid introduction element to a metering chamber;
a flexible diaphragm capable of substantial conformation to at least part of said metering chamber;
a plunger configured to compress and decompress said flexible diaphragm; and
a liquid exit element connected to said metering chamber having an outlet unidirectional valve.

8-9. (canceled)

10. A liquid dispenser apparatus according to claim 7 wherein said flexible diaphragm capable of substantial conformation to at least part of said metering chamber comprises a flexible diaphragm capable of substantial conformation to a wall of said metering chamber.

11-23. (canceled)

24. A liquid dispenser apparatus according to claim 7 and further comprising a dual clamp element.

25. A liquid dispenser apparatus according to claim 24 wherein said dual clamp element connects said liquid reservoir to said metering chamber and wherein said dual clamp connects said connected reservoir and metering chamber to an automated system.

26-28. (canceled)

29. A liquid dispenser apparatus according to claim 7 and further comprising an automated biological staining device.

30-31. (canceled)

32. A liquid dispenser apparatus according to claim 7 and further comprising an internal diaphragm compressor.

33. (canceled)

34. A liquid dispenser apparatus according to claim 7 wherein said metering chamber comprises a repeatable liquid measurement element.

35. (canceled)

36. A liquid dispenser apparatus according to claim 7 and further comprising an internal mechanical stop located in said metering chamber to stop displacement of said metering chamber at an uncompressed position.

37. A liquid dispenser apparatus according to claim 7 wherein said flexible diaphragm comprises an uncompressed position and a compressed position.

38-44. (canceled)

45. A liquid dispenser apparatus according to claim 7 and further comprising an actuator to which said plunger and said flexible diaphragm is responsive.

46. (canceled)

47. A liquid dispenser apparatus according to claim 7 and further comprising a compression element and a uncompression element.

48. A liquid dispenser apparatus according to claim 47 wherein said uncompression element comprises a spring.

49. A liquid dispenser apparatus according to claim 47 wherein said compression element comprises a manual compression element.

50-51. (canceled)

52. A liquid dispenser apparatus according to claim 7 wherein said outlet unidirectional valve comprises:
a valve disk;
a valve retainer; and
a valve membrane.

53-55. (canceled)

56. A liquid dispenser apparatus according to claim 52 wherein said valve disk and membrane comprises a seal.

57. A liquid dispenser apparatus according to claim 56 wherein said seal comprises a positive fluid seal.

58. (canceled)

59. A liquid dispenser apparatus according to claim 7 and further comprising a seal between said reservoir and said liquid introduction element.

60. A liquid dispenser apparatus according to claim 59 wherein said seal is selected from a group consisting of a radial o-ring and flange o-ring.

61-65. (canceled)

66. A liquid dispenser apparatus according to claim 7 and further comprising reservoir housing around said reservoir.

67-68. (canceled)

69. A liquid dispenser apparatus according to claim 7 wherein said reservoir comprises a collapsible molded reservoir and further comprising a reservoir collapse force less than a force required to uncompress said diaphragm.

70-72. (canceled)

73. A liquid dispenser apparatus according to claim 7 wherein said reservoir comprises an interchangeable reservoir.

74. A liquid dispenser apparatus according to claim 7 wherein said reservoir comprises a refillable reservoir.

75. A liquid dispenser apparatus according to claim 7 and further comprising a reduced friction dispenser.

76. (canceled)

77. A liquid dispenser apparatus according to claim 7 and further comprising a sealed system.

78. A liquid dispenser apparatus according to claim 7 and further comprising a self priming element.

79. A liquid dispenser apparatus according to claim 7 and further comprising a tip-down priming element.

80. A liquid dispenser apparatus according to claim 7 and further comprising a shipping lock.

81-86. (canceled)

87. A liquid dispenser apparatus according to claim 7 wherein said plunger is configured to horizontally displace said diaphragm.

88-95. (canceled)

96. A method of dispensing liquid comprising the steps of:
establishing liquid in a reservoir;
providing a metering chamber having a flexible diaphragm;
displacing said flexible diaphragm from a compressed position to an uncompressed position;
opening an inlet unidirectional valve which allows liquid to flow from said reservoir to said metering chamber;
flowing an amount of liquid from said reservoir to said metering chamber through said inlet unidirectional valve;
displacing said uncompressed diaphragm to a compressed position;
closing said inlet unidirectional valve;
opening an outlet unidirectional valve;
substantially conforming said diaphragm against at least part of said metering chamber;
distributing said amount of liquid from said metering chamber through said outlet unidirectional valve; and
closing said liquid output unidirectional valve.

97-169. (canceled)
